(19) United States
(12) Patent Application Publication
(10) Pub. No.: US 2026/0328292 A1
(43) Pub. Date: Oct. 22, 2026

(54) FLOATING SEAL

(71) Applicant: SKF Japan Ltd., Yokohama (JP)

(72) Inventors: Tasuku KOIKE, Nagano (JP); Masataka FURUYA, Nagano (JP)

(21) Appl. No.: 19/648,167

(22) Filed: Apr. 15, 2026

(30) Foreign Application Priority Data
Apr. 21, 2025 (JP) 2025-069537

(51) Int. Cl. F16J 15/44

(52) U.S. Cl. CPC F16J 15/441

(57) ABSTRACT

A floating seal mountable in a casing having a seal chamber in fluid communication with an air supply port includes first and second annular seal main bodies each having an outer lip and a contact seal lip connected by a flexible arm. An air flow adjustment ring is disposed axially between the outer lips and is configured to define with the outer lips and the casing a primary air chamber and is configured to define with the outer lips and a shaft a secondary air chamber. The adjustment ring has an air passage fluidically connecting the primary air chamber and the secondary air chamber. First and second floating amount adjustment members are disposed respectively in first and second accommodating recesses of the first and second main bodies between the outer lips and the flexible arms.

### CROSS-REFERENCE

This application claims priority to Japanese patent application no. 2025-069537 filed on Apr. 21, 2025, the contents of which are fully incorporated herein by reference.

### TECHNOLOGICAL FIELD

The present disclosure relates to the sealing of a rotating shaft (spindle). Specifically, the present disclosure relates to the sealing of a rotating shaft (spindle) of a machine having the rotating shaft (spindle) which shaft is configured to rotate at a high speed, for example, as part of a machine tool.

### BACKGROUND

In a machine having a rotating shaft (spindle) that is configured to rotate at a high speed, for example, a machine tool, the shaft is sealed in order to prevent contamination such as water or oil from being mixed in the machine.

Since such a spindle rotates at a high speed, a conventional contact seal wears out quickly and thus cannot be used (Japanese Unexamined Patent Application, First Publication No. 2024-042322). For this reason, a technology of providing a labyrinth having a labyrinth shape in a sealing device and performing air-purging to achieve sealing in a non-contact manner is used for the sealing of the spindle rotating at a high speed.

For example, Japanese Unexamined Patent Application, First Publication No. 2007-113786 discloses a technology of providing a labyrinth shape and performing air-purging to achieve sealing. In addition, technologies characterized in labyrinth shapes are disclosed as non-contact sealing technologies using air-purging in Japanese Unexamined Patent Application, First Publication Nos. 2010-076015 and 2006-043883.

On the other hand, Japanese Unexamined Patent Application, First Publication No. H06-226546 discloses a configuration in which a slit 26 is provided in a seal ring 18, so that the seal ring 18 comes into close contact with a seal plate 16 and seals the seal plate 16 when pressurization is performed by supplying a working fluid as a technology using a seal ring.

Although the non-contact sealing using air-purging as disclosed in Japanese

Unexamined Patent Application, First Publication Nos. 2007-113786, 2010-076015, and 2006-043883 can prevent wear due to contact with the spindle, it is necessary to continuously supply purge air for the sealing, and the consumption of air increases. Also, in the non-contact sealing of performing sealing with purge air, contamination (such as water or oil) may enter the machine due to a capillary phenomenon from the labyrinth shape when the machine is stopped.

The contact-type sealing is considered to be more advantageous in order to prevent contamination from being mixed when the machine is stopped. However, a general contact-type sealing cannot be used for sealing of a spindle that is rotating at a high speed due to severe wear as described above. On the other hand, the seal ring as disclosed in Japanese Unexamined Patent Application, First Publication No. H06-226546 does not contribute to prevention of entry of contamination (such as water or oil) when the machine is stopped because the sealing member is in a non-contact state when the working fluid is not supplied.

### SUMMARY

Therefore, the present disclosure provides a sealing structure capable of reducing consumption of purge air to a low level while realizing sealing of a spindle in a non-contact manner using the purge air.

Furthermore, the present disclosure provides a sealing structure configured to prevent entry of contamination (such as water or oil) even when a machine is stopped while performing non-contact sealing of a spindle with purge air.

According to a first aspect of the present disclosure, a floating seal is configured to be used in a casing or comprises the casing and further includes: a pair of seal main bodies, an air flow adjustment ring, and a pair of floating amount adjustment members. The casing is provided with an air supply port, and is provided with a seal chamber. The pair of seal main bodies comprise an elastic material and have an outer lip and a contact seal lip. The outer lip includes an outer wall portion, an inner wall portion, and an outer circumference contact portion. The outer wall portion is configured to contact an axial wall portion of the seal chamber, and the outer circumference contact portion is configured to contact a radial wall portion of the seal chamber. An elastic arm is provided to the inner wall portion, and the outer lip and the contact seal lip are connected by the elastic arm. The air flow adjustment ring comprises a resin material, has an air passage, and is arranged between the pair of seal main bodies. The pair of floating amount adjustment members are made of a resin material. Each of the pair of seal main bodies is provided with an accommodation recess between the outer lip and the contact seal lip connected by the elastic arm. Each of the pair of floating amount adjustment members is arranged in the accommodation recess provided to each of the pair of seal main bodies, respectively.

According to a second aspect of the present disclosure, the air flow adjustment ring forms a primary air chamber between the outer lip of each of the pair of seal main bodies and an outer peripheral surface of the air flow adjustment ring, and forms a secondary air chamber on an inner peripheral side of the air passage of the air flow adjustment ring.

According to a third aspect of the present disclosure, the air flow adjustment ring is configured of a first ring member and a second ring member. The first ring member and the second ring member each include a first surface and a second surface. The first surface of each of the first ring member and the second ring member is each provided with a radial recessed groove. The first surface of the first ring member and the first surface of the second ring member are combined facing each other to form the air flow adjustment ring. The radial recessed groove of the first ring member and the radial recessed groove of the second ring member are combined to form the air passage.

According to a fourth aspect of the present disclosure, the first ring member and the second ring member are configured to have the same shape. On the axial outside of the air flow adjustment ring configured by combining the first surface of the first ring member and the first surface of the second ring member facing each other, a third ring member having the same shape as the first ring member is arranged with a second surface of the third ring member facing the second surface of the first ring member, a fourth ring member having the same shape as the second ring member is arranged with a second surface of the fourth ring member facing the second surface of the second ring member. Each of the pair of floating amount adjustment members is configured by the third ring member and the fourth ring member.

According to the above-described floating seal, it is possible to suppress consumption of purge air to a low level while realizing sealing of a spindle in a non-contact manner using the purge air.

Furthermore, according to the above-described floating seal, it is possible to prevent entry of contamination (such as water or oil) even when a machine is stopped while performing non-contact sealing of a spindle with purge air.

### BRIEF DESCRIPTION OF THE DRAWINGS

FIG. 1 is a sectional side elevational view of a floating seal according to an embodiment of the present disclosure.

FIG. 2 is an enlarged sectional side elevation view of a portion of the floating seal of FIG. 1

FIG. 3 schematically illustrates a flow of purge air through the floating seal of FIG. 2.

FIG. 4 schematically illustrates the configuration of the seal of FIG. 3 when the purge air is not flowing.

FIG. 5 is a diagram illustrating a modification example of the floating seal according to the present disclosure.

FIG. 6 is a diagram illustrating a modification example of the floating seal according to the present disclosure.

### DETAILED DESCRIPTION

### Configuration of Present Disclosure

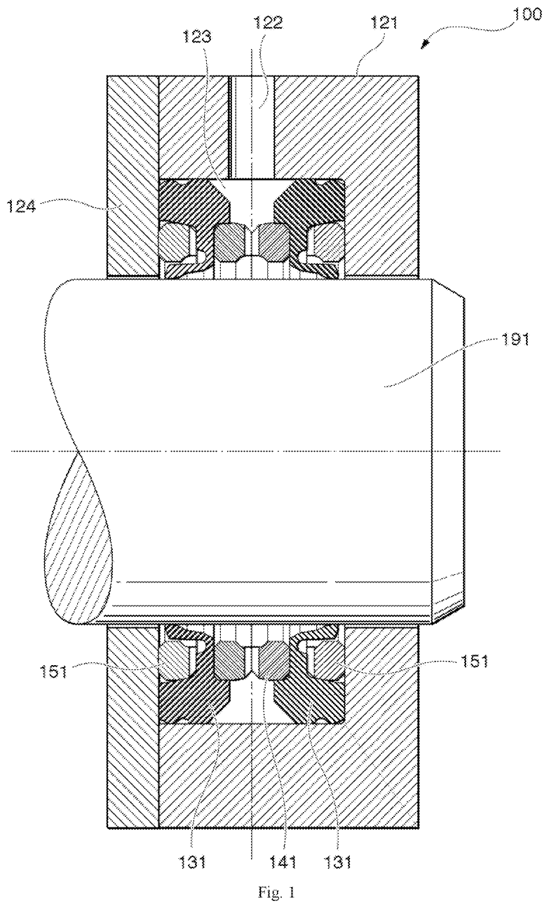

Hereinafter, an embodiment for carrying out the present disclosure will be described with reference to FIGS. 1 to 4.

An overall configuration of a floating seal 100 according to an embodiment of the present disclosure is illustrated in FIG. 1. As illustrated in FIG. 1, the floating seal 100 according to the embodiment of the present disclosure is provided on a rotating shaft (spindle) 191. The floating seal 100 includes a casing 121, seal main bodies 131, an air flow adjustment ring 141, and floating amount adjustment rings 151.

The casing 121 is provided on the spindle 191. The casing 121 includes a seal chamber 123 provided therein. An air supply port 122 for supplying purge air is provided so as to penetrate from the outer peripheral surface of the casing 121 to the seal chamber 123.

In the present embodiment, the seal chamber 123 provided inside the casing 121 is formed with one side in the axial direction opened, and the opening is closed by a seal fixing plate 124. However, the embodiment of the present disclosure is not limited to the configuration in which the seal chamber 123 having the opening is closed by the seal fixing plate 124, and it is only necessary to adopt a configuration in which a seal structure is accommodated inside the casing 121.

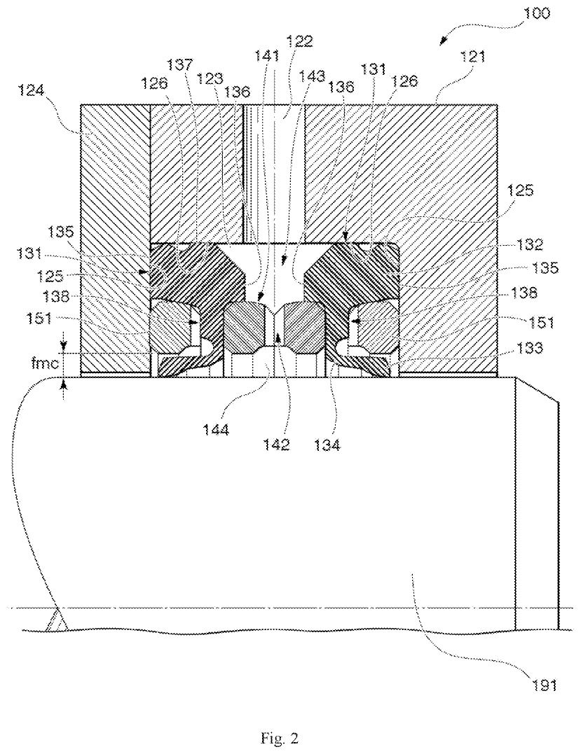

The pair of seal main bodies 131, the air flow adjustment ring 141 between the pair of seal main bodies 131, and the pair of floating amount adjustment rings 151 are arranged in the seal chamber 123 inside the casing 121. Hereinafter, main component configurations of the floating seal according to the embodiment of the present disclosure will be described on the basis of FIG. 2.

### Main Component Configurations of Seal

FIG. 2 illustrates main component configurations of the floating seal 100 according to the present embodiment. FIG. 2 only shows the upper half of the spindle 191 from the center line for convenience of explanation.

As illustrated in FIG. 2, the pair of seal main bodies 131, the air flow adjustment ring 141 arranged between the pair of seal main bodies, and the pair of floating amount adjustment rings 151 are arranged in the seal chamber 123 inside the casing 121 in the floating seal 100 according to the present embodiment.

The pair of seal main bodies 131 are configured to have the same shape, and the seal main bodies 131 having the same shape are axially symmetrically arranged with respect to the radial direction of the spindle 191 and spaced from each other in the axial direction of the spindle 191. Therefore, although one of the pair of seal main bodies 131 will be described below, the same explanation applies to both of the pair of seal main bodies 131.

The seal main body 131 is formed of an elastic or elastomeric material such as a thermoplastic polyurethane resin (TPU), for example. The seal main body 131 includes an outer lip 132 and a contact seal lip 133. The outer lip 132 includes an outer wall portion 135, an inner wall portion 136, and an outer circumference contact portion 137. The outer wall portion 135 abuts on an axial wall portion 125 of the seal chamber 123. The outer circumference contact portion 137 abuts on a radial wall portion 126 of the seal chamber 123. The seal main body 131 is held inside the seal chamber 123 through the abutment of the outer wall portion 135 on the axial wall portion 125 and the abutment of the outer circumference contact portion 137 on the radial wall portion 126.

An elastic arm 134 extends from the inner wall portion 136 of the outer lip 132. The contact seal lip 133 extends axially outward with respect to the axis of the spindle 191 from the elastic arm 134. The contact seal lip 133 has a contact portion with a rotating shaft outer peripheral surface 192 of the spindle 191. The elastic arm 134 can also be described as a flexible portion of the main seal body 131 that connects the contact seal lip 133 to the outer lip 132. The main seal body 131 may comprises a unitary elastomeric body that incudes the outer lip 132 and the contact seal lip 133.

In the seal main body 131 of the present embodiment, an accommodation recess 138 is formed between the outer lip 132 and the contact seal lip 133 by the elastic arm 134 extending from the outer lip 132 and by the contact seal lip 133 extending from the elastic arm 134. A floating amount adjustment ring, which will be described later, is arranged in the accommodation recess 138.

The air flow adjustment ring 141 is arranged between the pair of seal main bodies 131. The air flow adjustment ring 141 is formed of a hard resin such as polyoxymethylene (POM) or polyether ether ketone (PEEK), for example. The air flow adjustment ring 141 is held by inner wall portions 136 of the pair of seal main bodies 131.

A secondary air chamber 144 is provided as a space extending in the circumferential direction inside the air flow adjustment ring 141. The air flow adjustment ring 141 is provided with a slot (air passage) 142 extending in the radial direction of the spindle 191. The slot 142 is provided so as to establish communication between the outer peripheral surface of the air flow adjustment ring 141 and the secondary air chamber 144. The secondary air chamber 144 has a gap from the rotating shaft outer peripheral surface 192 of the spindle 191 so as to establish communication with the pair of seal main bodies 131.

The floating amount adjustment rings (floating amount adjustment members) 151 are arranged in the accommodation recesses 138 of the pair of seal main bodies 131, respectively. The floating amount adjustment rings 151 are configured to have the same shape, and the floating amount adjustment rings 151 having the same shape are axially symmetrically arranged in the respective accommodation recesses 138 with respect to the radial direction of the spindle 191 along the axial direction of the spindle 191. Therefore, although one of the pair of floating amount adjustment rings 151 will be described below, the same description is applied to both of the pair of floating amount adjustment rings 151.

The floating amount adjustment ring 151 is formed of a hard resin such as polyoxymethylene (POM) or polyether ether ketone (PEEK). The outer peripheral side of the floating amount adjustment ring 151 is accommodated in the accommodation recess 138 and is held in the space formed with the axial wall portion 125 of the seal chamber 123. The inner peripheral side of the floating amount adjustment ring 151 is configured to have a gap with which a floating amount clearance fmc is secured in the space formed with the rotating shaft outer peripheral surface 192. The contact seal lip 133 of the seal main body 131 is arranged at this floating amount clearance fmc in this configuration.

### Actions

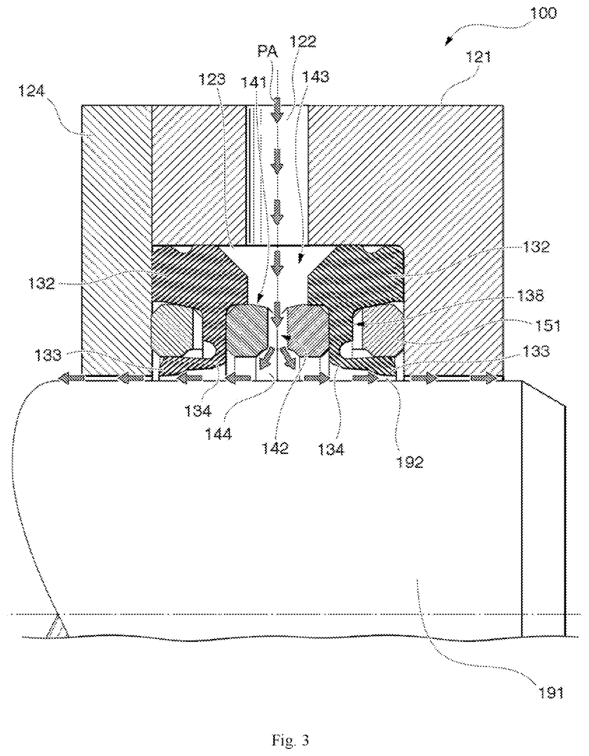

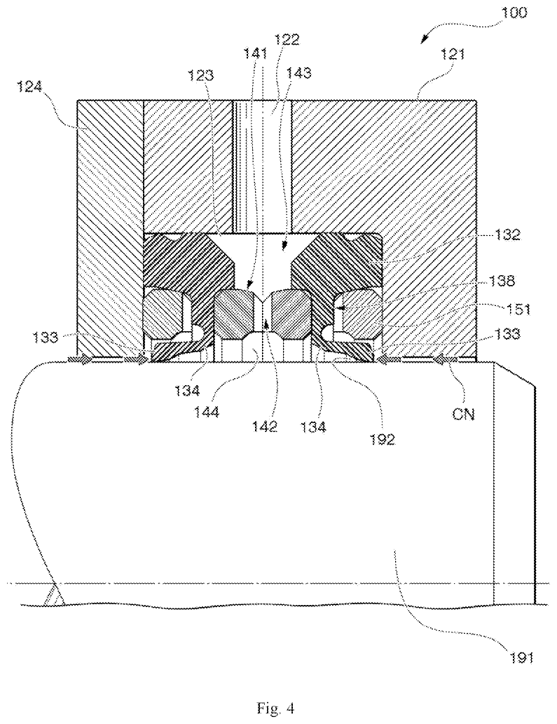

Actions of the present embodiment will be described on the basis of FIGS. 3 and 4.

### During Purge Air Supply

Actions of the present embodiment when the purge air PA is being supplied are shown in FIG. 3. As illustrated in FIG. 3, the purge air PA is introduced into the seal chamber 123 from the air supply port 122 of the casing 121.

As illustrated in FIG. 3, a primary air chamber 143 is configured between each of the outer lips 132 and 132 of the pair of seal main bodies 131 and the outer peripheral surface of the air flow adjustment ring 141 in the seal chamber 123. The purge air PA introduced into the seal chamber 123 is first introduced into the primary air chamber 143.

The purge air PA that has been introduced into the primary air chamber 143 is then introduced into the secondary air chamber 144 from the slot 142 provided at the air flow adjustment ring 141 so as to penetrate therethrough in the radial direction from the primary air chamber 143. The purge air PA that has been introduced into the secondary air chamber 144 flows axially outward along the rotating shaft outer peripheral surface 192.

The contact seal lip 133 floats due to an action of the elastic arm 134 with a pressure of purge air PA by the purge air PA flowing along the rotating shaft outer peripheral surface 192. The floating of the contact seal lip 133 is limited by the floating amount adjustment ring 151 due to the floating amount adjustment ring 151 arranged in the accommodation recess 138.

It is possible to configure non-contact sealing with the purge air PA by the floating amount of the contact seal lip 133 being limited by the floating amount adjustment ring 151 and by the gap between the contact seal lip 133 and the rotating shaft outer peripheral surface 192 being thereby adjusted. This makes it possible to prevent entry of foreign matter such as contamination CN (such as water or oil) due to the actions of the purge air PA.

### During Stop of Purge Air

Next, actions of the present embodiment when the purge air PA is stopped are shown in FIG. 4. As shown in FIG. 4, no purge air PA flows along the rotating shaft outer peripheral surface 192 if the purge air PA is stopped. For this reason, the pressure for pushing up the contact seal lip 133 is lost, and the contact seal lip 133 thus does not float and comes into contact with the rotating shaft outer peripheral surface 192.

At this time, the contact seal lip 133 comes into contact with the rotating shaft outer peripheral surface 192 to thereby establish sealing between the rotating shaft outer peripheral surface 192 and the contact seal lip 133. Therefore, it is possible to seal the spindle 191 without supplying the purge air PA.

### Effects

It is possible to achieve the following effects due to the above-described actions of the present embodiment.

First, since the seal main bodies 131 are formed of an elastic or elastomeric material such as a thermoplastic polyurethane resin (TPU), the amount of floating may not be stabilized, and it may not be possible to perform effective sealing if the floating is achieved only with the pressure of the purge air PA at the time of the supply of the purge air PA. In addition, since the amount of floating of the contact seal lip 133 cannot be adjusted, self-excited vibration may occur in the contact seal lip 133, and abnormal noise or vibration of the device may occur.

In this regard, the floating seal 100 according to the present embodiment includes the floating amount adjustment ring 151. The floating amount adjustment ring 151 is formed of a hard resin such as polyoxymethylene (POM) or polyether ether ketone (PEEK). Therefore, the floating amount of the contact seal lip 133 can be adjusted by giving rigidity to the seal main body 131 by the floating amount adjustment ring 151 as a hard material. It is thus possible to realize effective non-contact sealing while suppressing occurrence of self-excited vibration of the contact seal lip 133.

According to the present embodiment, it is possible to seal the spindle 191 by the contact seal lip 133 coming into contact with the rotating shaft outer peripheral surface 192 even if the supply of the purge air PA is stopped. It is thus possible to suppress consumption of the purge air PA and to prevent entry of the contamination CN such as water or oil into the machine when the machine is stopped.

### First Modification Example

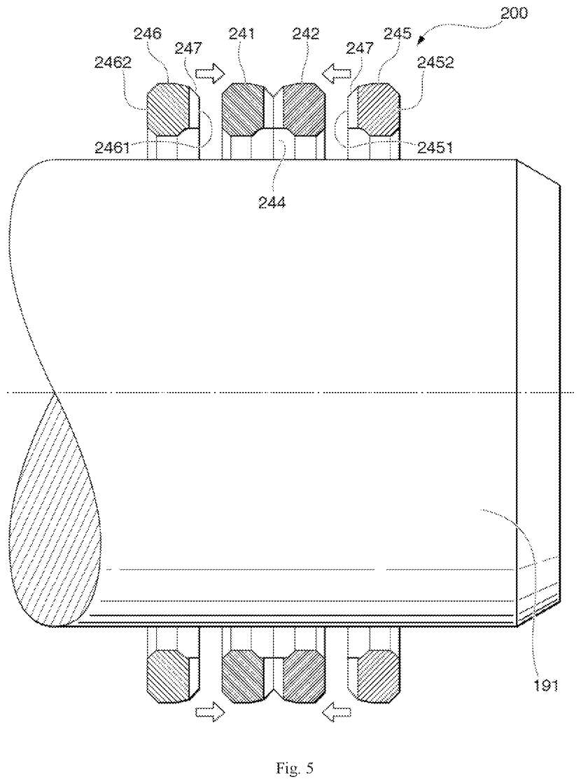

A modification example of the present embodiment is illustrated in FIG. 5. In the embodiment illustrated in FIGS. 2 to 4, the air flow adjustment ring 141 is a single element. However, the air flow adjustment ring may have a split structure like an air flow adjustment ring 214 included in a floating seal 200 illustrated in FIG. 5.

The air flow adjustment ring 241 illustrated in FIG. 5 is configured of two elements, namely a first ring member 245 and a second ring member 246. The first ring member 245 has a first surface 2451 and a second surface 2452. Similarly, the second ring member 246 has a first surface 2461 and a second surface 2462.

The first surface 2451 of the first ring member 245 is provided with a radial recessed groove 247. The first surface 2461 of the second ring member 246 is also provided with a radial recessed groove 247.

Here, the air flow adjustment ring 241 is configured by the first surface 2451 of the first ring member 245 and the first surface 2461 of the second ring member 246 being combined to face each other as illustrated in FIG. 5. In the air flow adjustment ring 241, a slot (air passage) 242 is configured by the radial recessed groove 247 of the first ring member 245 and the radial recessed groove 247 of the second ring member 246 being combined.

### Second Modification Example

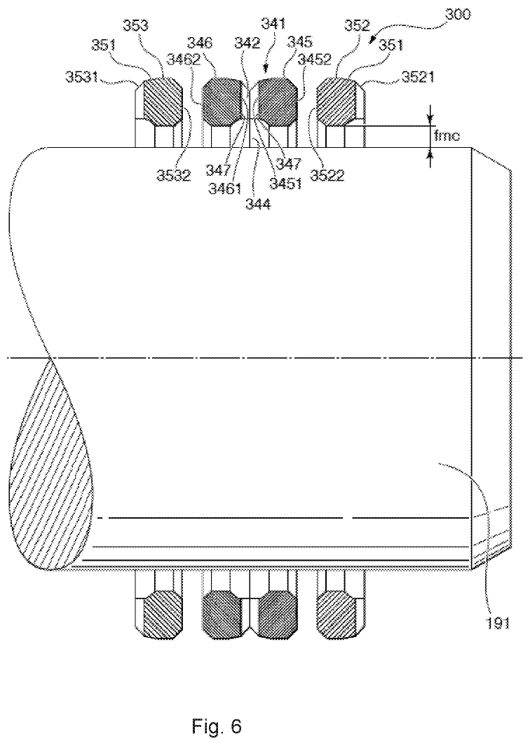

A second modification example of the embodiment of the present disclosure is illustrated in FIG. 6. It is possible to share components both as the air flow adjustment ring and as the floating amount adjustment ring by configuring the first ring member 245 and the second ring member 246 constituting the air flow adjustment ring 241 in the embodiment of the present disclosure to have the same shape and using a ring with the same shape as that of these rings for the floating amount adjustment ring.

In a floating seal 300 illustrated in FIG. 6, an air flow adjustment ring 341 is configured of a first ring member 345 and a second ring member 346 similarly to the air flow adjustment ring 241 in the first modification example.

In the second modification example, the first ring member 345 and the second ring member 346 are configured to have the same shape.

Furthermore, a third ring member 352 having the same shape as that of the first ring member 345 is arranged with a second surface 3522 of the third ring member 352 facing a second surface 3452 of the first ring member 345 on the axially outer side of the air flow adjustment ring 341 in the floating seal 300 according to the second modification example. A fourth ring member 353 having the same shape as that of the second ring member 346 is arranged with a second surface 3532 of the fourth ring member 353 facing a second surface 3462 of the second ring member 346.

The floating amount adjustment rings 351 and 351 are configured by the third ring member 352 and the fourth ring member 353, respectively.

According to the configuration of the second modification example, it is possible to share the components by configuring the first ring member 345 and the second ring member 346 constituting the air flow adjustment ring 341, and the third ring member 352 and the fourth ring member 353 constituting the floating amount adjustment rings 351 and 351 to have the same shape.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved floating seals.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A floating seal mountable in a casing having a seal chamber in fluid communication with an air supply port, the floating seal comprising:
an annular first seal main body having a first outer lip and a first contact seal lip connected to the first outer lip by a first flexible arm, the first outer lip having a first axially facing outer wall portion configured to contact a first axially facing wall portion of the seal chamber, a first axially facing inner wall portion and a first radially outer circumferential contact portion configured to contact a first radially facing wall portion of the seal chamber,
an annular second seal main body having a second outer lip and a second contact seal lip connected to the second outer lip by a second flexible arm, the second outer lip having a second axially facing outer wall portion configured to contact a second axially facing wall portion of the seal chamber, a second axially facing inner wall portion and a second radially facing outer circumferential contact portion configured to contact a second radially facing wall portion of the seal chamber,
an air flow adjustment ring disposed axially between the first seal main body and the second seal main body, the air flow adjustment ring configured to define with the first seal main body and the second seal main body and the casing a primary air chamber and configured to define with the first seal main body and the second seal main body and a shaft a secondary air chamber, the air flow adjustment ring having an air passage fluidically connecting the primary air chamber and the secondary air chamber,
a first floating amount adjustment member located in a first accommodating recess in the first seal main body between the first outer lip and the first flexible arm, and
a second floating amount adjustment member located in a second accommodating recess in the second seal main body between the second outer lip and the second flexible arm.

2. The floating seal according to claim 1,
wherein the first and second seal main bodies are formed from an elastomer.

3. The floating seal according to claim 1,
wherein the first and second seal main bodies are formed from thermoplastic polyurethane and first and second floating amount adjustment members are formed from polyoxymethylene (POM) or polyether ether ketone (PEEK).

4. The floating seal according to claim 1,
wherein the first and second floating amount adjustment members are annular.

5. The floating seal according to claim 1,
wherein the air flow adjustment ring comprises a first ring member having a first surface having a first groove and a second ring member having a second surface having a second groove,
wherein the first surface of the first ring member contacts the second surface of the second ring member and the first groove and the second groove together form the air passage,

6. The floating seal according to claim 3,
wherein the first ring member and the second ring member have a same shape, and
wherein the first floating amount adjustment member and the second floating amount adjusting ring have the same shape.

7. A device comprising:
a casing having a seal chamber and having an annular though opening having a diameter,
the floating seal according to claim 1 mounted in the seal chamber with the first axially facing outer wall portion contacting the first axially facing wall portion of the seal chamber and the first radially outer circumferential contact portion contacting the first radially facing wall portion of the seal chamber and the second axially facing outer wall portion contacting the second axially facing wall portion of the seal chamber and the second radially outer circumferential contact portion contacting the second radially facing wall portion of the seal chamber, and
a shaft having an outer diameter less than the diameter of the annular through opening and extending though the casing such that the first contact seal lip and the second contact seal lip contact the shaft.

8. The device according to claim 7,
wherein the first floating amount adjustment member is spaced from the first contact seal lip by a first radial gap and the second floating amount adjustment member is spaced from the second contact seal lip by a second radial gap.

9. The device according to claim 8,
wherein a flexibility of the first flexible arm is sufficient to allow the first contact seal lip to contact the first floating amount adjustment member and a flexibility of the second flexible arm is sufficient to allow the second contact seal lip to contact the second floating amount adjustment member.

10. The floating seal according to claim 9,
wherein the first and second seal main bodies are formed from an elastomer.

11. The floating seal according to claim 9,
wherein the first and second seal main bodies are formed from thermoplastic polyurethane and first and second floating amount adjustment members are formed from polyoxymethylene (POM) or polyether ether ketone (PEEK).

12. The floating seal according to claim 9,
wherein the first and second floating amount adjustment members are annular.

13. The floating seal according to claim 9,
wherein the air flow adjustment ring comprises a first ring member having a first surface having a first groove and a second ring member having a second surface having a second groove,
wherein the first surface of the first ring member contacts the second surface of the second ring member and the first groove and the second groove together form the air passage, 14. The floating seal according to claim 13,
wherein the first ring member and the second ring member have a same shape, and
wherein the first floating amount adjustment member and the second floating amount adjusting ring have the same shape.
